(19) United States
(12) Patent Application Publication
(10) Pub. No.: US 2009/0294582 A1
(43) Pub. Date: Dec. 3, 2009

(54) Propulsion Unit for Lighter-Than-Air Aircraft

(76) Inventors: Silvain Michel, Kusnacht (CH); Gabor Kovacs, Oberweningen (CH); Patrick Lochmatter, Uster (CH)

Correspondence Address: WINSTEAD PC, P.O. BOX 50784, DALLAS, TX, 75201, US

(21) Appl. No.: 11/918,333

(22) PCT Filed: Apr. 7, 2006
(86) PCT No.: PCT/CH2006/000198

§ 371 Date: Jan. 6, 2009

(30) Foreign Application Priority Data
Apr. 12, 2005 (CH) 660/05

(51) Int. Cl. B64B 1/24

(52) U.S. Cl. 244/62

(57) ABSTRACT

A lighter-than-air aircraft is propelled via a bending-rotating tail whip. Two actuating areas located on opposite sides in a rear area of a lifting gas body are shortened by activated actuators. A vertical plane of symmetry of the lifting gas body and thus, the lifting gas body itself, are pivoted in an area of bending zones about angles a and β. An activated state exists when the actuator performs work for propelling the aircraft. Propulsion can be provided by deformation of the lifting gas body. Changes in direction can also be effected by asymmetrical sequences of movements.

### BACKGROUND OF THE INVENTION

1. Technical Field

The present invention relates to a lighter-than-air flying vehicle according to the preamble of the independent patent claim.

2. History of Related Art

There are many lighter-than-air flying vehicles of known art, for example from WO 00/73142 (D1). Airscrews, propellers or impellers are exclusively used for the propulsion of lighter-than-air flying vehicles. However, for lighter-than-air flying vehicles these propulsion concepts have a poor efficiency as a result of the poor ratio between the large cross-sectional area of the vehicle, generating air resistance, and the relatively small circular area swept by the propeller or impeller and with it the associated large difference in velocity between the propulsive airflow and the wake.

D1 discloses a typical propulsion means for a lighter-than-air flying vehicle with two airscrews for forward propulsion and swivelling thruster engines for control. In the case of airships the propulsion means are usually attached to the gondola for static loading reasons, although this position is not optimal for the flow incident onto the control surfaces, amongst other reasons. The propulsion concept disclosed in D1 has the above-mentioned disadvantages.

In particular for energy-autonomous lighter-than-air flying vehicles, for example for solar-driven aerostatic communications platforms, or for energy-saving airships operating over long ranges and periods of time, for example for monitoring and remote-sensing tasks, a propulsion means that is as energy-efficient as possible is of key significance.

### SUMMARY OF THE INVENTION

The object of the present invention consists in the creation of a lighter-than-air flying vehicle with a more energy-efficient propulsion means compared with conventional propulsion concepts based on airscrews.

The achievement of this object is reproduced in the characterising part of claim 1 with regard to its essential features, and in the following claims with regard to further advantageous embodiments.

### BRIEF DESCRIPTION OF THE DRAWINGS

A more complete understanding of the lighter-than-air flying vehicle of the present invention may be obtained by reference to the following Detailed Description, when taken in conjunction with the accompanying Drawings, wherein:

FIG. 1 shows a schematic representation of a lighter-than-air flying vehicle according to the prior art in a side view;

FIG. 2a shows a schematic representation of a first example of embodiment of a an inflatable airship with an extended gas-filled lifting body in a plan view;

FIG. 2b shows a schematic representation of a first example of embodiment of an inflatable airship with a deformed gas-filled lifting body in a plan view;

FIGS. 3a-d show a schematic representation of the movement sequence for a second example of embodiment of a deformable gas-filled lifting body according to the invention in a plan view; and

FIGS. 4a-b show a schematic representation of a third example of embodiment of an inflatable airship in a side view.

### DETAILED DESCRIPTION OF THE DRAWINGS

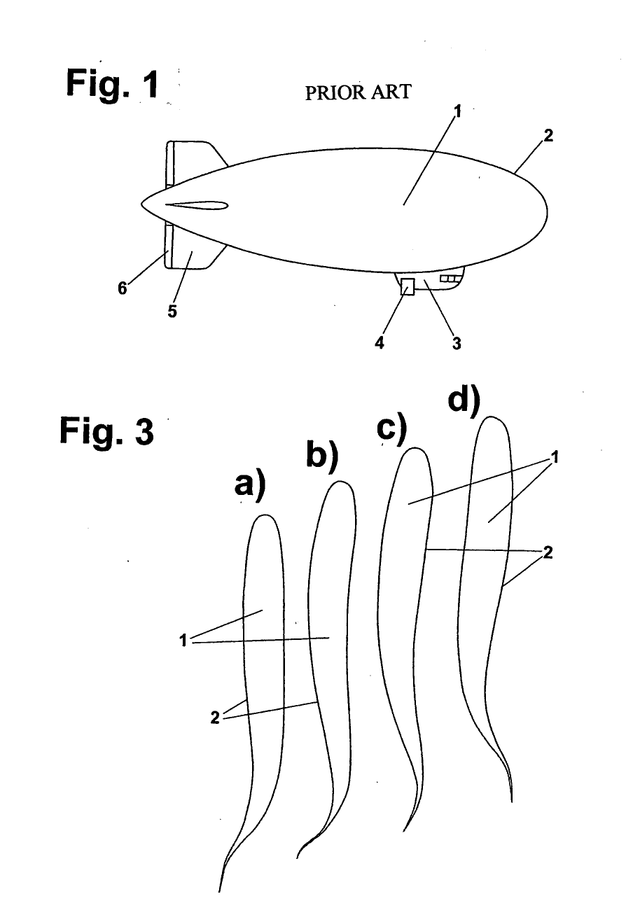

FIG. 1 shows an airship according to the prior art. The appearance of lighter-than-air flying vehicles is marked by a large gas-filled lifting body 1 manufactured with a gas-tight covering 2, which when filled with a lighter-than-air gas produces the static lift that balances the vehicle's own weight and payload. In order to be able to move the large volume with as low an air resistance as possible, the gas-filled lifting body 1 is usually configured in the shape of a droplet or a spindle. A rigid gondola 3 attached underneath the gas-filled lifting body 1 serves to accommodate the payload and—in the case of manned airships—the crew. The propulsion means 4 for forward propulsion and control can also be attached to the gondola 3. Control surfaces 5 in the stem region of the gas-filled lifting body 1 provide stabilisation of direction of the airship in forward flight and at their trailing edges can have swivelling flaps 6, by means of which vertical and lateral alterations of course can be effected.

In airship construction a differentiation is made between rigid, semi-rigid and non-rigid airships. Rigid airships have a rigid skeleton that supports the whole of the gas-filled lifting body, gives it its shape, and by means of which the payload can be directed onto the gas-filled lifting body. Semi-rigid airships have, for example, just a keel leading from the bow to the stem, onto which, for example, the gondola and control surfaces are attached. Compared with rigid and semi-rigid airships, non-rigid airships—also known as inflatable airships or blimps—have the advantage in that they can be evacuated and thus require significantly less space for storage. In the case of inflatable airships the weight of the gondola 3 can be distributed by means of stressed cables or webs onto the covering.

Although in what follows mention is made only of inflatable airships, the propulsion concept according to the invention can in an analogous manner also be transferred across to semi-rigid and rigid airships with swivel joints in the keel or skeleton.

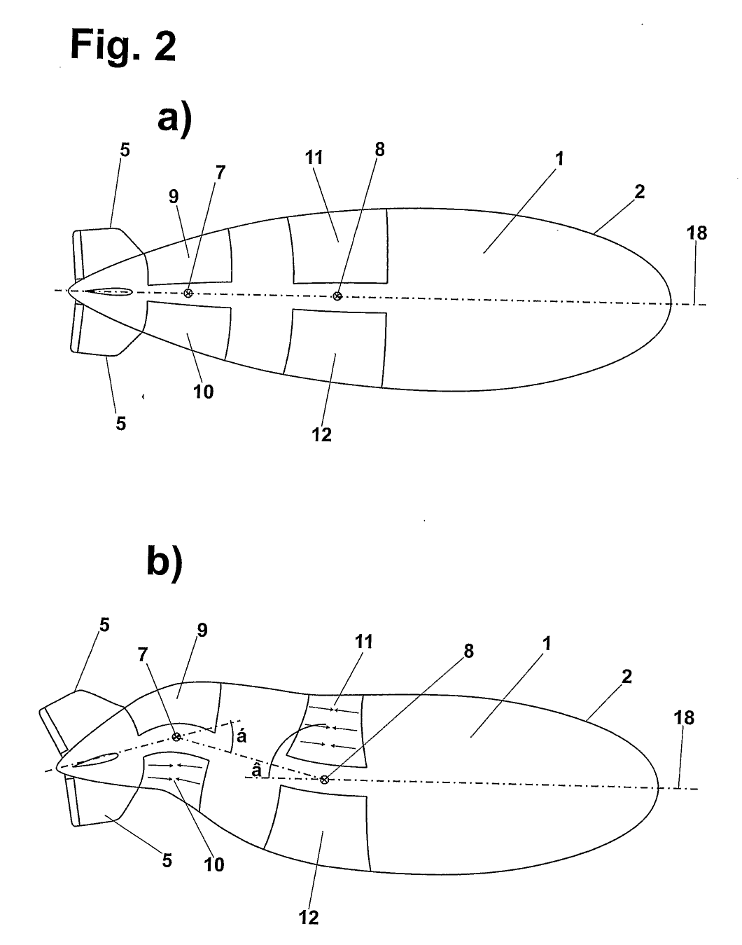

FIG. 2 shows a first example of embodiment of an inflatable airship with propulsion means according to the invention by deformation of the gas-filled lifting body.

In aquatic forms of life, in particular in fishes, this form of propulsion is widespread, and in the course of species development has been perfected. Many scientific publications are concerned with the investigation of a means of locomotion similar to that to fishes and its technical simulation, for example for robot fishes.

The idea of the present invention is to adapt this energy-efficient means of locomotion to airships. The spectrum of generation of forward propulsion by means of deformation of the body extends from that of anguiliforms—fishes that are similar to eels, and move the whole body in an undulating manner—through to thuniforms—fishes with shapes similar to tuna with essentially rigid bodies, and slender half-moon shaped vertical fins that move relative to the body.

The first example of embodiment schematically represented in FIG. 2 of a deformable inflatable airship has essentially two swivelling axes in the stern region and moves in a manner similar to a trout when swimming quickly—on this point see also the movement sequence represented in FIG. 3.

FIG. 2a shows the extended gas-filled lifting body 1 from above. In the stern region of the gas-filled lifting body 1 two swivelling axes 7, 8 are indicated to provide a better understanding of the movement. In the case of an inflatable airship these swivelling axes 7, 8 cannot be accurately localised. Instead one can talk about bending zones 7, 8. In the region of these swivelling axes 7, 8, or bending zones 7, 8, the covering 2 of the gas-filled lifting body 1 has four separately activated lateral actuator regions 9-12, the two actuator regions 9, 10 and the two actuator regions 11, 12 acting as agonist-antagonist pairs. In these actuator regions 9-12 actuators are present on or in the covering 2, by means of which the covering 2 can be shortened in the longitudinal direction. In this manner the gas-filled lifting body 1 bends around the bending zones 7, 8. Electroactive polymers (EAPs) or dielectric elastomers based on the attractive force of electrically charged coatings can, for example, be used as actuators. These are thin, light, and with efficiencies of up to 70% achievable, are energy-efficient. Also conceivable is the use of a plurality of linear actuators, example artificial muscles, for actuator regions 9-12 in place of one or a plurality of two-dimensional actuators.

In FIG. 2b the gas-filled lifting body 1 is represented in a doubly curved manner. Two actuator regions 10, 11 lying on opposite sides are shortened by means of actuators that have been activated. The vertical plane of symmetry 18 of the gas-filled lifting body 1, and with it the gas-filled lifting body 1 itself, is deflected in the region of the bending zones 7, 8 by the angles α and β. In what follows activation of an actuator always signifies a shortening of the actuator. An activated state is deemed to be that state by the assumption of which the actuator performs work for the forward propulsion of the inflatable airship. It should be noted that actuators made from dielectric elastomers lengthen with the application of an electrical voltage. Such an actuator made from a dielectric elastomer (DEA) thus assumes the activated state when no electrical voltage is present.

Not only forward propulsion can be generated by deformation of the gas-filled lifting body 1. By means of asymmetric movement sequences alterations of direction can be effected in addition to forward propulsion. Thus in the example of embodiment represented in FIG. 2 lateral alterations of direction can be executed even without flaps 6 on the vertical control surface 5.

FIGS. 3a-d show in part the movement sequence for a second example of embodiment of a deformable gas-filled lifting body 1 according to the invention. The movement sequence is similar to that of a trout when swimming quickly. The trout belongs to the carangiforms, and its generation of forward propulsion is positioned between that of the anguliforms and the thuniforms. Together with the vertical fins the rear part of the body is deformed during swimming. Three essentially rigid bodies, which are connected with one another by means of two swivel joints 7, 8, provide a simplified model for an intermediate stage between a pure vertical fin stroke and the undulating forward propulsion technique used by eels. These swivel joints 7, 8 oscillate in an essentially sinusoidal manner, and coupled with a phase displacement, where this phase displacement amounts to approximately 70° for the bending-rotating-flipping stroke represented in FIG. 3 with maximum forward propulsion. However, it can be selected according to the desired propulsion means depending on whether a force generating forward propulsion, or a neutral or braking force is to be generated.

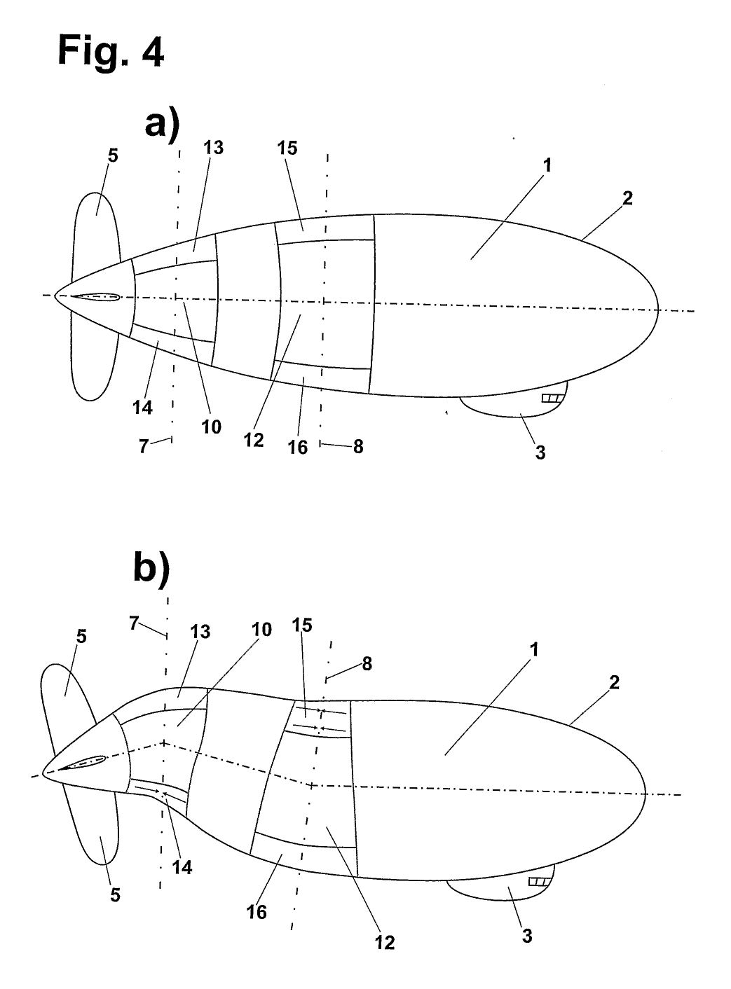

In FIG. 4 a third example of embodiment of an inflatable airship according to the invention is represented in a side view. FIG. 4a shows the gas-filled lifting body 1 in the extended state; FIG. 4b in the doubly curved state.

In addition to the lateral actuator regions 9-12 present in the first example of embodiment in FIG. 2 additional upper actuation regions 13, 15 and lower actuation regions 14, 16 are also present in the region of the bending zones 7, 8 and likewise serve to shorten the covering 2 in the longitudinal direction. These additional actuator regions 13-16 allow the deformation of the gas-filled lifting body 1 in the vertical plane and thus together with a vertical bending-rotating-flipping stroke also enable height control of the inflatable airship. It is conceivable to distribute the covering 2 in the bending zones into more than eight actuation regions, or to configure the actuator regions in an overlapping manner. Lifting gas bodies 1 with more than two bending zones 7, 8 and related actuator regions 9-16 are likewise contained within the concepts of the invention. With many bending zones 7, 8 an undulating deformation of the gas-filled lifting body 1 is also possible. Such forward propulsion has, however, with regard to energy efficiency disadvantages compared with the bending-rotating-flipping stroke and is moreover essentially more difficult to implement technically.

The above-described generation of forward propulsion in a manner similar to fishes can also be used for other lighter-than-air flying vehicles, for example for rigid or semi-rigid airships. For this purpose the rigid parts must be fitted with swivel joints in order that the gas-filled lifting body 1 can execute the necessary swivelling movements.

1. A lighter-than-air flying vehicle with a gas-filled lifting body having a gas-tight flexible covering, comprising:
means for deformation of the gas-filled lifting body;
wherein the deformations consist of at least one bending of a longitudinal axis of the gas-filled lifting body; and
wherein said deformations of the gas-filled lifting body effect a propulsion means for the lighter-than-air flying vehicle.

2. The lighter-than-air flying vehicle according to claim 1, wherein a control of the lighter-than-air flying vehicle takes place by said deformation of the gas-filled lifting body.

3. The lighter-than-air flying vehicle according to claim 1, wherein the lighter-than-air flying vehicle is an inflatable airship.

4. The lighter-than-air flying vehicle according to claim 3, further comprising actuator regions having a plurality of actuators, wherein said plurality of actuators are present laterally on the gas-filled lifting body in a region of the bending zones, wherein a shortening of the plurality of actuators effect a shortening of a covering essentially in a longitudinal direction of the gas-filled lifting body.

5. The lighter-than-air flying vehicle according to claim 3, further comprising actuator regions having a plurality of actuators, wherein said plurality of actuators are present above and below the gas-filled lifting body in a region of the bending zones, wherein a shortening of the plurality of actuators effect a shortening of a covering essentially in a circumferential direction of the gas-filled lifting body.

6. The lighter-than-air flying vehicle according to claim 3, wherein electroactive polymers (EAPS) or dielectric elastomers based on an attractive force of electrically charged coatings are used as actuators in a plurality of actuator regions.
